(19) United States
(12) Patent Application Publication
(10) Pub. No.: US 2025/0135844 A1
(43) Pub. Date: May 1, 2025

(54) DUAL HEAT EXCHANGER

(71) Applicant: Hanon Systems, Daejeon (KR)

(72) Inventors: Hynek Hruza, Novy Jicin (CZ); Martin Sopuch, Novy Jicin (CZ); Lukas Pastrnak, Novy Jicin (CZ); Toni Spies, Kerpen (DE); Florian Bieregger, Hallbergmoos (DE); Niklas Thielen, Kerpen (DE); Lukas Bloemer, Kerpen (DE); Gregor Duennwald, Kerpen (DE)

(21) Appl. No.: 18/865,766

(22) PCT Filed: Nov. 3, 2023
(86) PCT No.: PCT/KR2023/017439

§ 371 Date: Nov. 14, 2024

(30) Foreign Application Priority Data
Jun. 5, 2023 (DE) 102023205224.5

(51) Int. Cl. B60H 1/32

(52) U.S. Cl. CPC B60H 1/3227

(57) ABSTRACT

A dual heat exchanger includes a first plate heat exchanger in which heat is transferred between a first fluid and a second fluid, and a second plate heat exchanger in which heat is transferred between the first fluid in a first state and the first fluid in a second state, and is characterized in that the two heat exchangers are separated from one another only by means of a separation plate.

### CROSS REFERENCE TO RELATED PATENT APPLICATIONS

This is a U.S. national phase patent application of PCT/KR2023/017439 filed Nov. 3, 2023 which claims the benefit of and priority to German Patent Application No. DE 10 2023 205 224.5 filed on Jun. 5, 2023, the entire contents of each of which are incorporated herein by reference for all purposes.

### TECHNICAL FIELD

The invention relates to a dual heat exchanger comprising two plate heat exchangers.

### BACKGROUND ART

Air-conditioning condensers in which a refrigerant is condensed on a coolant, typically a water-glycol mixture, are known in particular for the air-conditioning of electric vehicles. This is ensured by a first heat exchanger, through which two different fluids thus flow. A second heat exchanger is furthermore provided for the refrigerant, which is typically present in the overall circuit in both a high-pressure and a low-pressure state, and serves to transfer heat between the fluid in these two states.

Up to now, the two heat exchangers were connected by means of suitable lines and/or connections, which requires a comparatively large amount of installation space and individual parts.

### SUMMARY

Against this background, the invention is based on the object of creating a dual heat exchanger that requires a comparatively small amount of installation space and/or a small number of individual parts.

This object is solved by the heat exchanger described herein and shown in the drawings.

According thereto, this heat exchanger comprises a first plate heat exchanger in which heat is transferred between a first fluid and a second fluid, for example a refrigerant on the one hand and a water-glycol mixture on the other, in particular each with a proportion of approximately 50%. Further provided is a second plate heat exchanger in which heat is transferred between the first fluid in a first state and the first fluid in a second state. This is typically the refrigerant in a high-pressure state on the one hand and in a low-pressure state on the other. The dual heat exchanger according to the invention is characterized in that the two plate heat exchangers are separated from one another only by means of a separation plate. Any lines, connections and the like between the two heat exchangers can, however, be advantageously avoided. The amount of required space can furthermore be significantly reduced.

The invention is essentially based on the basic idea of allowing two plate heat exchangers to directly abut one another, separated only by a separation plate, whilst nevertheless ensuring, as will be described in more detail below, the required fluid flows by means of suitable measures. In other words, all the plates of the two heat exchangers as well as the separation plate are aligned substantially parallel and preferably congruent to one another. This allows a particularly compact design to be achieved. The plates of the respective heat exchanger have a suitable distance from one another such that intermediate spaces are defined, in which fluid can flow. The separation plate is configured with substantially the same distance to the respectively adjacent, so to speak the closest, plates of the two heat exchangers. This results in a plate stack of a plurality of plates, each having substantially the same distance to one another, which, however, forms two fluidically separated heat exchangers. Furthermore, as will be described in more detail below, at least one additional separation plate may be provided to separate two or more regions of a heat exchanger from one another. The plates may, for example, be soldered together to form tight flow channels therebetween as well as possibly one or more bypasses extending through a plurality of plates.

As already indicated, the heat exchanger according to the invention can advantageously be used for heat transfer between a fluid in two different states if the states differ in terms of pressure.

This also applies to the preferred use of a refrigerant as the first fluid and a water-glycol mixture as the second fluid, generally when using a coolant.

In order to ensure the necessary fluid flows despite the compact design, it is advantageous if at least one plate heat exchanger comprises at least one bypass for the fluid to be conducted to the other plate heat exchanger.

Unwanted heat transfer can hereby be advantageously minimized in that at least one bypass comprises a tube made, for example, of plastic.

A bypass in the form of a tube can advantageously lead to a dryer and can be attached to and fluidically connected to a holder to which the dryer is also attached and fluidically connected.

The tube may furthermore be arranged at a distance from a plurality of opening edges of the plates such that a further bypass is formed between the tube and the opening edges, which may be connected in a suitable manner.

A bypass can thus be formed in an advantageous manner by means of opening edges that are connected with one another, for example soldered together.

The heat exchanger according to the invention can advantageously be used for two separate refrigerant circuits if the second heat exchanger comprises two inlets for the fluid in a first state, in particular a low-pressure state. It is advantageous with respect to the surrounding components if the two inlets are located on opposite sides. It should be noted that the two refrigerant circuits can be used, for example, for air conditioning a front area of the interior of a car on the one hand and a rear area of the interior of a car on the other.

Advantages with respect to heat transfer are also expected if at least one heat exchanger can be flowed through in countercurrent.

As regards the first heat exchanger, it can furthermore be advantageous from an energy point of view if it comprises a subcooling section for the refrigerant. This section can be advantageously separated by means of a separation plate so that the compact design is still retained despite the additional subcooling section.

Moreover, it is currently preferred that the first heat exchanger additionally comprises a dryer.

It can furthermore be advantageous in terms of flow if at least one intermediate space between the plates is blocked such that at least one heat exchanger comprises at least one blocking member, in particular a ring, between at least two plates.

A particularly efficient design of the heat exchanger results if a plurality of, preferably all, the plates of at least one, preferably both heat exchangers as well as the separation plate are aligned substantially parallel and preferably congruent to one another.

At least one rib can advantageously be provided in an efficient manner in at least one plate to separate different regions of the heat exchanger and/or, parallel to one another, for example in a straight or zigzag manner, to form fluid channels.

Favorable flow conditions in a distribution region arise as a result of a plurality of protrusions, in particular circular protrusions, that are preferably provided.

The heat exchanger according to the invention preferably comprises a bracket for fastening to surrounding components.

This bracket preferably comprises at least one plate portion that is in particular parallel to the plates of the heat exchanger, and at least one bent portion that is preferably used for fastening to surrounding components, for example by means of screw connections.

### DESCRIPTION OF DRAWINGS

Embodiments of the invention will be explained in more detail below with reference to the figures. These show:

FIGS. 1A, 1B: first sectional views of the heat exchanger according to the invention, FIG. 1B being an enlargement of the lower part of FIG. 1A;

FIGS. 2A, 2B: second sectional views of the heat exchanger according to the invention, FIG. 2B being an enlargement of the lower part of FIG. 2A;

FIG. 3: a dryer;

FIGS. 4 to 6: a supply line and holder of the dryer of FIG. 3 in different views;

FIGS. 7 to 10: a holder of the heat exchanger according to the invention in different views;

FIG. 11: a side view of the heat exchanger of FIGS. 1 and 2;

FIG. 12: a perspective view of essential parts of the heat exchanger of FIG. 11;

FIGS. 13 and 14: an alternative embodiment in a side and perspective view of essential parts;

FIG. 15: a sectional top view of the heat exchanger of FIG. 11,

FIGS. 16 and 17: details thereof;

FIG. 18: a top view of a plate with a blocking member; and

FIG. 19: a sectional view of the design of FIG. 18.

### DESCRIPTION OF AN EMBODIMENT

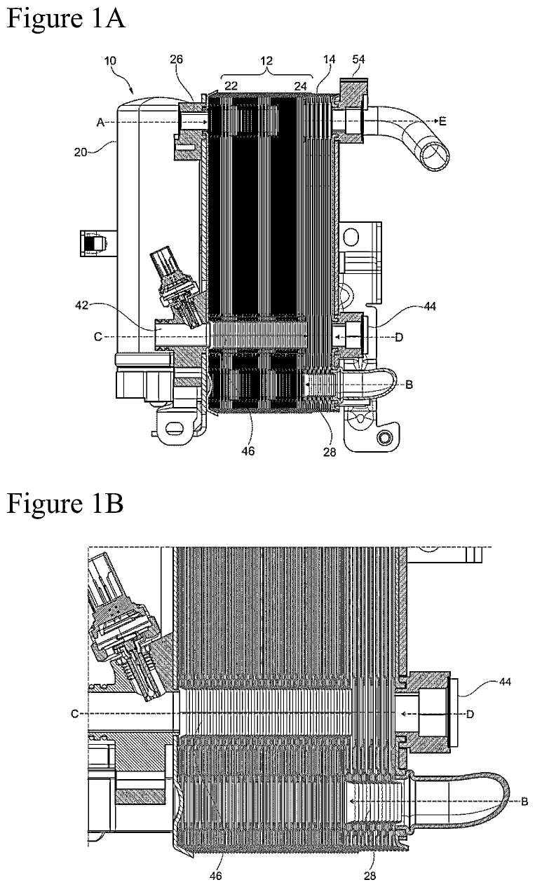

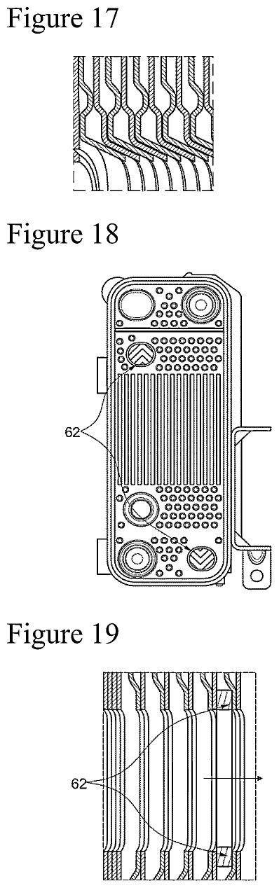

As regards the dual heat exchanger 10 shown in FIG. 1, it should first of all be explained that this heat exchanger comprises a dryer 20 on the left of the figure, and that the first heat exchanger 12, which comprises a condensation section 22 and a subcooling section 24, connects thereto in the region of the recognizable plates. The dryer 20 is substantially cylindrical, may also be referred to as a “bottle”, and its longitudinal axis is substantially parallel to the plane of the plates of the heat exchangers and to the longer edge of the typically rectangular plates. The second heat exchanger 14 is located on the far right of the figure, and it is apparent that the two heat exchangers 12, 14 are separated from one another only by means of a suitable separation plate and that the two sections 22, 24 of the first heat exchanger 12 are also separated from one another only by means of a further separation plate. As mentioned above, the plates may, for example, be soldered together to form tight flow channels therebetween as well as possibly bypasses extending through a plurality of plates, such as the bypass 46 shown in FIGS. 16 and 17. For a particularly efficient design of the heat exchanger, preferably all the plates as well as the separation plate are the same size and are aligned substantially parallel and preferably congruent to one another.

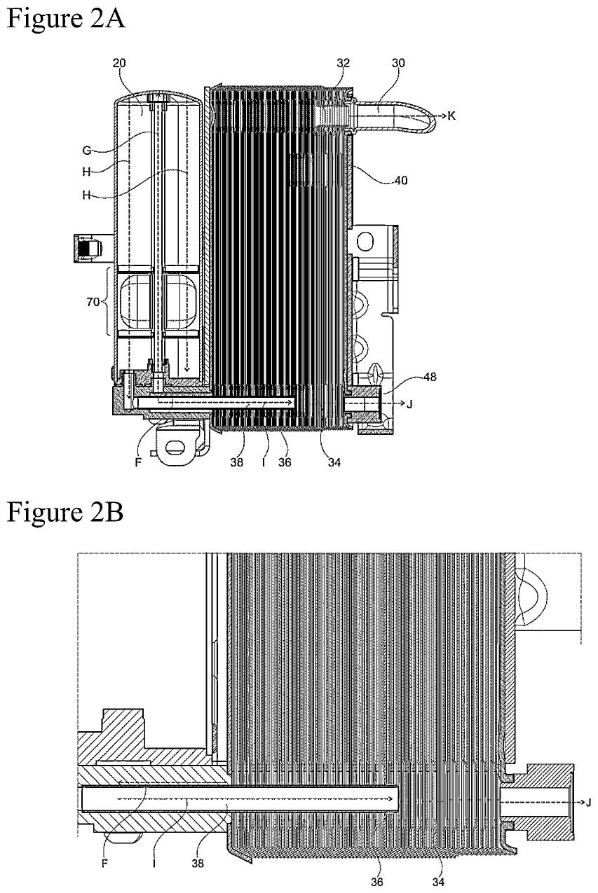

The fluid flows are essentially as follows. According to the orientation in the figure, gaseous refrigerant that is under high pressure enters the condensation section 22 of the first heat exchanger 12 via the port 26 in the direction of arrow A and, according to the figure, flows downwards in all the intermediate spaces between the plates of this section as well as substantially diagonally, when viewed from the side, to the port shown at the bottom of FIG. 2, which is located behind the drawing plane of FIG. 1.

According to FIG. 1, coolant is supplied in countercurrent from the lower right according to arrow B, which first of all flows through a suitable bypass 28 through the second heat exchanger 14 and then disperses across all the intermediate spaces between the plates of both sections 22, 24 of the first heat exchanger 12, hereby flowing, again viewed from the left side in FIG. 1, towards the top left to the outlet 30 for the coolant shown on the right in FIG. 2, see arrow K. A bypass 32 is again provided through the second heat exchanger 14. The aforementioned port 26 and outlet 30, as well as similar components cited below, may be soldered to one or more plates, in particular to an outermost plate.

The separation plate 34 between the heat exchangers 12 and 14 and the separation plate 36 between the sections 22 and 24 of the first heat exchanger 12 are apparent in the lower region of FIG. 2. Although the separation plates 34, 36 are only clearly apparent in the lower region, it goes without saying that they, as well as all the other plates, extend to the upper end of the heat exchangers 12, 14, so that said heat exchangers and/or sections are separated from one another. With regard to the separation plate 36, this has the effect that, in the lower region, the refrigerant entering from the top left according to FIG. 1 flows leftwards into the dryer 20 according to arrow F in the annular cavity surrounding the inner tube 38 and flows upwards in the dryer according to arrow G, then downwards according to arrows H and from there through the tube 38 into the subcooling section 24 according to arrow I. Here, the tube 38 forms a bypass, so to speak, through the condensation section 22. In the adjacent subcooling section 24, heat transfer with the coolant takes place, here in co-current, which, according to FIG. 1, enters section 24 at the bottom according to arrow B, then flows, so to speak in the drawing plane, in the intermediate spaces between the plates and, in accordance with the cross-section located therebehind as shown in FIG. 2, exits this section at the top right according to arrow K.

The coolant accordingly flows from the front (FIG. 1, arrow B) to the rear (FIG. 2, arrow K) with respect to the drawing plane, and the refrigerant in the subcooling section 24 flows from the rear (FIG. 2, arrow I) to the front (FIG. 1), however, the flow upwards in the figures does not extend to the upper end of the subcooling section 24, but rather only to the passage 40 to the second heat exchanger 14, in which heat transfer with the refrigerant in a low-pressure state takes place. As is apparent in the lower region of FIG. 1, this refrigerant is supplied, in the shown example, according to arrows C, D through two ports 42, 44 disposed on opposite sides, and, in the case shown, is guided through a bypass 46 through the entire first heat exchanger 12. It is discharged according to arrow E through port 54 in the upper region, and the outlet 48 for the high-pressure refrigerant is apparent according to arrow J in the lower right of FIG. 2. Heat is in particular usually transferred from the refrigerant present at low pressure to the high pressure refrigerant via the already subcooled refrigerant. At least one, preferably all, of the inlets, outlets, passages and bypasses preferably extend perpendicular to the plane of the plates. The plate stack of the second heat exchanger 14 is approximately as thick as the subcooling section 24, and the plate stack of the first heat exchanger 12 is approximately twice as thick.

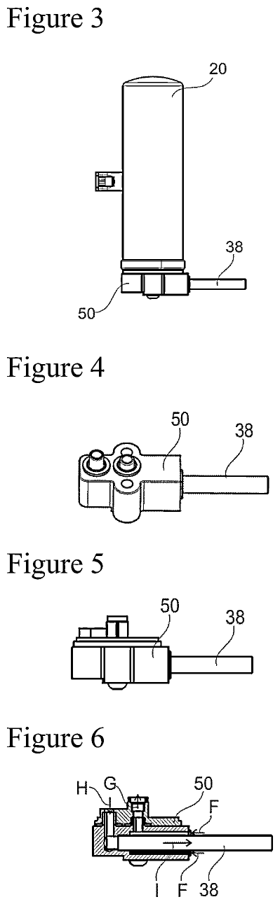

FIG. 3 shows, in detail, the dryer 20 comprising a holder 50 and the tube 38 extending therefrom. The sectional view of FIG. 6 corresponds to that of FIG. 2, bottom, and the necessary openings for fluid flow to and from dryer 20 are apparent in FIGS. 4 and 5. The central opening is in particular connected to the hollow space around the tube 38 and is used for inflow into the dryer 20. The left opening is used for outflow and, as is apparent in particular in FIG. 6, is connected to the tube 38. The flow of the high-pressure refrigerant is as shown in FIG. 2 by arrows F, G, H and I and extends around the tube 38 in the direction of the dryer 20 according to arrow F, upwards in the dryer 20 according to arrow G, from there downwards into the holder 50 according to arrow H and further through the tube 38 according to arrow I. The two upper and lower openings, which are in particular apparent in FIG. 4, are used for fastening the dryer 20 to the holder 50.

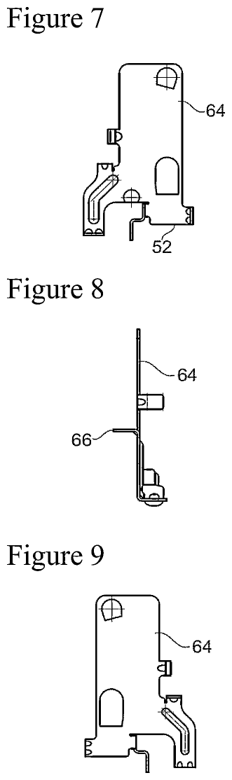

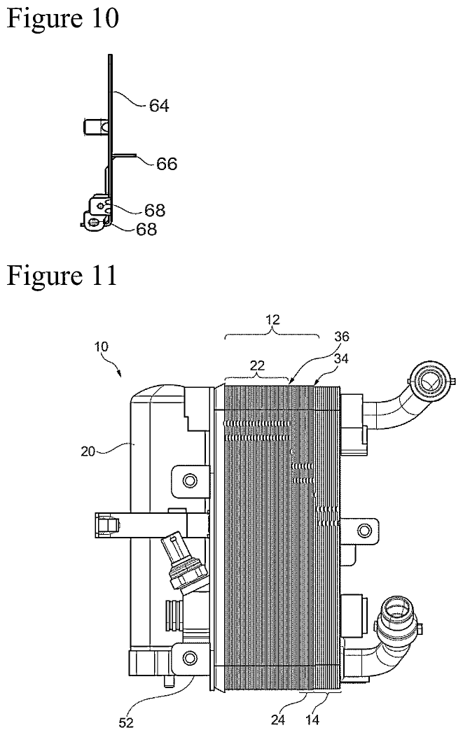

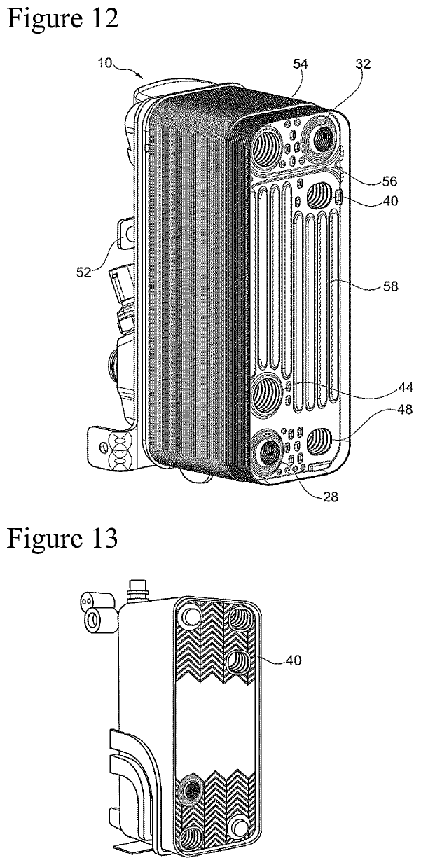

A bracket 52 with a plate portion 64 is shown in FIGS. 7 to 10, which is also apparent in the left region of FIGS. 11 and 12 and is used for fastening to surrounding components. This is in particular the case for the recognizable bent portions 66, whereas the plate portion 64 of the bracket 52 abuts the plates of the heat exchanger. Fastening to the heat exchanger or to surrounding components takes place by means of soldering or screw connections via the visible openings 68 in the bent portions 66.

FIG. 11 shows a side view of the dual heat exchanger 10 shown in FIG. 1 comprising the dryer 20, the first heat exchanger 12, the second heat exchanger 14 as well as the sections 22 and 24 of the first heat exchanger 12 and the separation plates 36 and 34 arranged between said sections or heat exchangers, respectively.

Shown in FIG. 12 is a plate of the second plate heat exchanger 14. In this figure, the bypass 32 for the coolant, as already shown in FIG. 2, is located at the top right, the port 54 for discharging the refrigerant in a low-pressure state is located at the top left, the passage 40 for the refrigerant from the subcooling section 24 to the second heat exchanger 14 is located therebelow on the right, the bypass 28 for the coolant to the first heat exchanger 12 is located at the bottom left, the supply line 44 for low-pressure refrigerant is located above it, and the outlet 48 for the high-pressure refrigerant is located at the bottom right. The rib 56 in the upper region, which runs parallel to the shorter edge of the plate and can be seen between the outlet 30 and the port 54 on the one hand and the passage 40 on the other, ensures separation between the low-pressure and the high-pressure refrigerant in the shown plate. In the plate therebeneath, a corresponding rib is formed underneath the port 44 and the heat transfer region 58 formed between the ports. In the case shown, the heat transfer region 58 is formed by a plurality of channels parallel to the longer edge of the plate that are formed by ribs.

It should be noted that the passage 40 from the subcooling section to the second heat exchanger may also be located on the other side, according to the orientation in said figures on the left. Furthermore, the ribs of the heat transfer region 58 may be configured narrower than in said figures and not extend into the region adjacent to the passage 40 or the port 44.

Distribution regions are located between the heat transfer region 58 and the ports as well as between the ports, and these may be provided with more than the shown number of protrusions in the form of circular protrusions (dimples), in particular if the ribs are shorter.

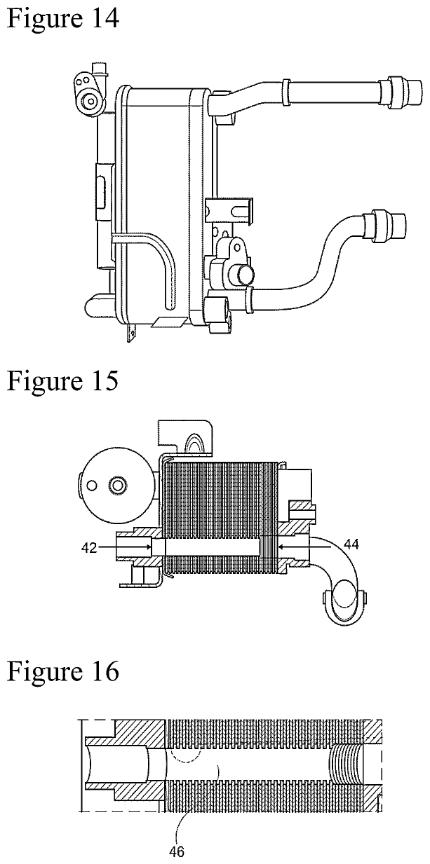

It is shown in FIG. 13 that the distribution regions may also comprise zigzag ribs, and that individual ports, such as the passage 40 in the shown case, can also be formed at a different location, in the right half according to FIG. 13 or in the rear region according to FIGS. 1 and 2. FIG. 14 shows a side view of the embodiment of FIG. 13, which otherwise substantially corresponds to that of FIGS. 1 and 2.

FIG. 15 shows a sectional top view in the region of ports 42 and 44 for the low-pressure refrigerant. As is apparent from FIGS. 16 and 17, all the plates in this region, in particular at the opening edges, can be bent and soldered together such that the intermediate spaces between the plates are sealed, resulting in the described bypass 46.

In certain cases of use, it is also advantageous to block individual intermediate spaces between plates to reduce heat transfer. By blocking individual intermediate spaces between plates in this way, the pressure loss can be kept low in an advantageous manner. In the case shown in FIGS. 18 and 19, a blocking member in the form of a ring 62 is provided, for example, for the high-pressure region. As a result hereof, heat transfer can, as mentioned, be optimized without increasing the number of channels for the low-pressure refrigerant, which would lead to an undesirable increase in pressure loss. The blocking member may be connected to the plates by means of soldering.

The invention relates to a dual heat exchanger comprising two plate heat exchangers.

1-18. (canceled)

19. A dual heat exchanger comprising a first plate heat exchanger in which heat is transferred between a first fluid and a second fluid, and a second plate heat exchanger in which heat is transferred between the first fluid in a first state and the first fluid in a second state, wherein the two heat exchangers are separated from one another only by means of a separation plate (34).

20. The dual heat exchanger according to claim 19, wherein the two states of the first fluid differ in terms of pressure.

21. The dual heat exchanger according to claim 19, wherein the first fluid is a refrigerant and/or the second fluid is a coolant.

22. The dual heat exchanger according to claim 19, wherein at least one of the first plate heat exchanger and the second plate heat exchanger further comprises at least one bypass for a fluid to be conducted to an other of the first plate heat exchanger and the second plate heat exchanger.

23. The dual heat exchanger according to claim 22, wherein at least one bypass further comprises a tube.

24. The dual heat exchanger according to claim 23, wherein the tube is attached to and fluidically connected to a holder to which a dryer is also attached and fluidically connected.

25. The dual heat exchanger according to claim 23, wherein the tube is arranged at a distance from a plurality of opening edges of plates of the first plate heat exchanger.

26. The dual heat exchanger according to claim 22, wherein the at least one bypass is formed by means of opening edges of plates of the first plate heat exchanger that are connected with one another.

27. The dual heat exchanger according to claim 19, wherein the second plate heat exchanger further comprises two inlets for the first fluid in a first state, which are provided on opposite sides.

28. The dual heat exchanger according to claim 19, wherein at least one of the first plate heat exchanger and the second plate heat exchanger can be flowed through in countercurrent.

29. The dual heat exchanger according to claim 19, wherein the first plate heat exchanger further comprises a subcooling section separated by means of a separation plate.

30. The dual heat exchanger according to claim 19, wherein the first plate heat exchanger further comprises a dryer.

31. The dual heat exchanger according to claim 19, wherein at least one of the first plate heat exchanger and the second plate heat exchanger further comprises at least one blocking member between at least two plates for blocking an intermediate space between the at least two plates.

32. The dual heat exchanger according to a claim 19, wherein a plurality of plates of at least one of the first plate heat exchanger and the second plate heat exchanger as well as the separation plate are aligned substantially parallel to one another.

33. The dual heat exchanger according to claim 19, at least one plate further comprises at least one rib to separate different regions of the first plate heat exchanger and the second plate heat exchanger and/or, parallel to one another to form fluid channels.

34. The dual heat exchanger according to claim 19, wherein at least one plate further comprises a plurality of protrusions in at least one distribution region.

35. The dual heat exchanger according to claim 19, wherein it further comprises at least one bracket for fastening to surrounding components.

36. The dual heat exchanger according to claim 35, wherein the at least one bracket further comprises at least one plate portion that is parallel to plates of the heat exchanger, and at least one bent portion that is used for fastening to surrounding components.
